(19) United States
(12) Patent Application Publication
(10) Pub. No.: US 2025/0106311 A1
(43) Pub. Date: Mar. 27, 2025

(54) METHOD AND SYSTEM FOR DETERMINING QUIC STREAMS IN REAL-TIME APPLICATIONS

(71) Applicant: Samsung Electronics Co., Ltd., Suwon-si (KR)

(72) Inventors: Sukhdeep SINGH, Bangalore (IN); Madhan Raj KANAGARATHINAM, Bangalore (IN); Avinash BHAT, Bangalore (IN)

(21) Appl. No.: 18/971,931

(22) Filed: Dec. 6, 2024

Related U.S. Application Data
(63) Continuation of application No. PCT/KR2023/007075, filed on May 24, 2023.

(30) Foreign Application Priority Data
Jun. 20, 2022 (IN) 202241035243
Mar. 31, 2023 (IN) 202241035243

(51) Int. Cl. H04L 69/164; H04L 41/16; H04L 65/80

(52) U.S. Cl. CPC H04L 69/164; H04L 41/16; H04L 65/80

(57) ABSTRACT

Embodiments of the disclosure disclose a method and a network node for selecting QUIC streams in wireless communication. As such, current values associated with network parameters related to a data session in real-time are received by network node in a wireless communication system. The network parameters include at least one of: connection metrics, network condition and a type of service. As such, new values of the network parameters for the data session are predicted by the network node using an artificial intelligence (AI) model based on the current values. A plurality of QUIC streams related to the data session are determined based on new network parameters. Each QUIC stream of the plurality of QUIC streams is selected from at least: reliable QUIC stream, semi-reliable QUIC stream, and unreliable QUIC stream. The plurality of QUIC streams are streamed in the wireless communication system.

### CROSS-REFERENCE TO RELATED APPLICATIONS

This application is a continuation of International Application No. PCT/KR2023/007075 designating the United States, filed on May 24, 2023, in the Korean Intellectual Property Receiving Office and claiming priority to Indian Provisional Patent Application No. 20/224,1035243, filed on Jun. 20, 2022, and to Indian Complete patent application Ser. No. 20/224,1035243, filed on Mar. 31, 2023,in the Indian Patent Office, the disclosures of each of which are incorporated by reference herein in their entireties.

### BACKGROUND

### Field

The disclosure relates to transport layer network protocol and, for example, to a method and system for determining quick user datagram protocol (UDP) internet connections (QUIC) streams in real-time applications.

### Description of Related Art

The transport layer of the open systems interconnection (OSI) model is responsible for delivering data to and from a connected device's communication port. Several transport layer communication protocols exist today that have different drawbacks and benefits. For example, protocols like the user datagram protocol (UDP) supports time-sensitive data flow without offering additional services like reliability, security, etc. On the other hand, the transmission control protocol (TCP) is a connection-oriented method of transmitting data that provides reliability but with increased overhead costs. The applications that use TCP are often bottle-necked by its handshake mechanism, which undesirably incurs delay, particularly in a time-sensitive environment (streaming live video, etc.). Due to exponential increase in the amount of traffic that flows through the Internet, the existing applications must deal with significantly larger volumes of data and therefore cannot tolerate the delay caused by TCP. However, adopting and updating any new revision is a slow process in the present state of the art because TCP is built in the system kernel.

Quick UDP internet connections (QUIC) may refer to a new user-space protocol developed that uses UDP as its substrate. QUIC packets are identified by unique packet numbers that are inserted inside QUIC headers. The packet number of each outgoing packet is monotonically higher than the packet number of the previously sent packet. QUIC keeps track of the received packets with the help of packet numbers and sends an acknowledgement (ACK) frame to acknowledge a given packet. QUIC may send a combined ACK for more than one received packet. QUIC also has a provision for ACK-eliciting packet, which specifies a packet for which the transmitting side anticipates an ACK from the receiver. The sent packet for which an ACK is not received is considered as lost packet. Despite all desirable features provided by QUIC, the delay caused by the QUIC protocol is not small enough to effectively support packet exchange required in a real-time environment.

When packet loss is encountered, QUIC reacts by re-transmitting lost data, sending an updated frame, or discarding the lost frame. QUIC endpoints prioritize retransmission of data over sending new data, unless priorities specified by the application indicate otherwise. Packet loss deteriorates the overall performance of QUIC, primarily when used to support time-sensitive applications like real time video streaming and the like. This problem stated above escalates further when data is being carried over wireless networks like Wi-Fi, which are inherently prone to effects like path loss, fading, etc. QUIC handles loss recovery by retransmission of packets, however, this introduces extra delays for lost packets which increases latency.

In view of the above discussion, there exists a need for QUIC streams for real-time applications. Furthermore it would be advantageous to improve the latency of the QUIC streams to support real-time applications.

The above information is presented as background information only to assist with an understanding of the disclosure. No determination has been made, and no assertion is made, as to whether any of the above might be applicable as prior art with regard to the disclosure.

### SUMMARY

According to an example embodiment, a method for selecting quick user datagram protocol (UDP) internet connection (QUIC) streams in wireless communication is disclosed. The method includes: receiving, by a network node in a wireless communication system, current values associated with one or more network parameters related to a data session in real-time, the one or more network parameters comprising at least one of: connection metrics, network condition and a type of service; determining, by the network node, a plurality of QUIC streams related to the data session based on the current values associated with the one or more network parameters, each QUIC stream of the plurality of QUIC streams being selected from at least: a reliable QUIC stream, a semi-reliable QUIC stream, and an unreliable QUIC stream, wherein the plurality of QUIC streams are streamed in the wireless communication system.

According to an example embodiment, a method for selecting quick user datagram protocol (UDP) internet connection (QUIC) streams in wireless communication is disclosed. Current values associated with one or more network parameters related to a data session in real-time are received by a network node in a wireless communication system. The one or more network parameters include at least one of: connection metrics, network condition and a type of service. The method includes predicting, by the network node using an artificial intelligence (AI) model, new values associated with the one or more network parameters for the data session based on the current values associated with the one or more network parameters. The method includes determining, by the network node, a plurality of QUIC streams related to the data session based on the new values associated with the one or more network parameters. Each QUIC stream of the plurality of QUIC streams is selected from at least: a reliable QUIC stream, a semi-reliable QUIC stream, and an unreliable QUIC stream. The plurality of QUIC streams are streamed in the wireless communication system.

According to an example embodiment, a network node for selecting quick user datagram protocol (UDP) internet connection (QUIC) streams in a wireless communication system is disclosed. The network node includes: memory and at least one processor, comprising processing circuitry. The memory stores instructions and an artificial intelligence (AI) model. The instructions, when executed by the at least one processor individually and/or collectively, cause the network node to: receive current values associated with one or more network parameters related to a data session in real-time, the one or more network parameters include at least one of: connection metrics, network condition and a type of service; predict new values associated with the one or more network parameters for the data session based on the current values associated with the one or more network parameters using the AI model; determine a plurality of QUIC streams related to the data session based on the new values associated with the one or more network parameters, each QUIC stream of the plurality of QUIC streams being selected from at least: a reliable QUIC stream, a semi-reliable QUIC stream, and an unreliable QUIC stream, wherein the plurality of QUIC streams are streamed in the wireless communication system.

According to an example embodiment, one or more non-transitory computer-readable storage media storing one or more computer programs including computer-executable instructions that, when executed by at least one processor, cause a network node to perform operations is disclosed. The operations comprises receiving, by the network node, current values associated with one or more network parameters related to a data session in real-time, wherein the one or more network parameters comprise at least one of: connection metrics, network condition and a type of service, and determining, by the network node, a plurality of QUIC streams related to the data session based on the current values associated with the one or more network parameters, wherein each QUIC stream of the plurality of QUIC streams is selected from at least: a reliable QUIC stream, a semi-reliable QUIC stream, and an unreliable QUIC stream, and wherein the plurality of QUIC streams are streamed in the wireless communication system

To further illustrate the advantages and features of the disclosure, a more particular description will be rendered by reference to various example embodiments thereof, which are illustrated in the appended drawings. It is appreciated that these drawings merely depict example embodiments of the disclosure and are therefore not to be considered limiting its scope. The disclosure will be described and explained with additional specificity and in greater detail with reference to the accompanying drawings.

### BRIEF DESCRIPTION OF THE DRAWINGS

The above and other aspects, features, and advantages of certain embodiments of the disclosure will be more apparent from the following detailed description, taken in conjunction with the accompanying drawings, in which like characters represent like parts throughout the drawings, and in which:

FIG. 1 is diagram illustrating an example of a wireless communication system related to various embodiments;

FIG. 2 is a block diagram illustrating an example configuration of a network node for dynamically selecting QUIC streams in the wireless communication system, according to various embodiments;

FIG. 3 is a diagram illustrating an example deep learning model (DRL) model for predicting new values associated with one or more network parameters based on current values associated with the one or more network parameters, according to various embodiments;

FIG. 4 is a diagram illustrating example multiplexing the plurality of QUIC streams in a single socket for a data session, according to various embodiments;

FIG. 5 is a signal flow diagram illustrating an example of a network node dynamically selecting QUIC streams in a wireless communication system for a data session, according to various embodiments;

FIG. 6A is a flowchart illustrating an example method for dynamically selecting QUIC streams in a wireless communication system, according to various embodiments; and

FIG. 6B is a flowchart illustrating a method for dynamically selecting QUIC streams in the wireless communication system, according to various embodiments.

Further, skilled artisans will appreciate that elements in the drawings are illustrated for simplicity and may not have necessarily been drawn to scale. For example, the flowcharts illustrate the method in terms of operations involved to help to improve understanding of various aspects of the disclosure. Furthermore, in terms of the construction of the device, one or more components of the device may have been represented in the drawings by conventional symbols, and the drawings may show those specific details that are pertinent to understanding the various example embodiments of the disclosure so as not to obscure the drawings with details that may be readily apparent to those of ordinary skill in the art.

### DETAILED DESCRIPTION

It may be advantageous to set forth definitions of certain words and phrases used throughout this disclosure. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, refer, for example, to inclusion without limitation. The term “or” is inclusive, meaning and/or. The phrase “associated with,” as well as derivatives thereof, may refer, for example, to including, being included within, interconnecting with, contain, being contained within, connecting to or with, coupling to or with, being communicable with, cooperating with, interleaving, juxtaposing, being proximate to, being bound to or with, having, having a property of, having a relationship to or with, or the like. The term “controller” may refer, for example, to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, may refer, for example, to different combinations of one or more of the listed items being used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this disclosure. Those of ordinary skill in the art will understand that in many, if not most instances, such definitions apply to prior as well as future uses of such defined words and phrases.

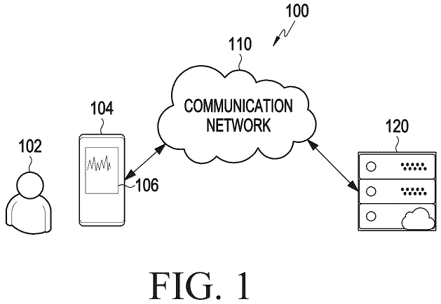

FIG. 1 through FIG. 6B, discussed below, and the various embodiments used to describe the principles of the disclosure are by way of illustration only and should not be construed in any way to limit the scope of the disclosure. Those skilled in the art will understand that the principles of the disclosure may be implemented in any suitably arranged system or device.

The term ‘network node’ as used herein may refer, for example, to any node which acts as a connection point in a network infrastructure of a distributed wireless communication network. Each node is an endpoint for data transmissions or redistribution in the wireless communication network. Nodes have either a programmed or engineered capability to recognize, process and forward transmitted data to other network nodes. Some examples of network nodes include, but not limited to, routers, switches, hubs, gateways, user equipment, wireless base stations, and the like. It shall be noted that both physical and virtual instances of many of these types of nodes are possible.

The term ‘data session’ as used herein may refer, for example, to a set of user interactions with a software application within a given time frame. In an example, data session in conjunction with a real-time gaming application may include user interactions in which gaming data is downloaded, user login/authentication is performed, display of gaming dashboard, audio, text and other multimedia content for a specified time period such as, 5 minutes. In general, the data session may include multiple page views, events, social interactions, and e-commerce transactions across one or more software applications.

The term ‘dynamically determining QUIC streams’ as used herein may refer, for example, to selecting a plurality of QUIC streams for the data session in real-time based on forecasted network parameters. The QUIC streams may be any of: reliable QUIC stream, unreliable QUIC stream, semi-reliable QUIC stream, or any combination of the above in a single socket/connection and are determined based on prediction of the network parameters for the data session.

The reliable QUIC streams offer re-transmissions of lost data packets. As such, the reliable QUIC maintains a retransmission timer and a queue of data packets for retransmission incase an acknowledgement is not received as determined from the retransmission timer. In general, the reliable QUIC gives priority to retransmission of lost data packets and there is large latency involved with reliable QUIC streams which are not essentially fast enough to support real-time applications. The unreliable QUIC streams are not reliable and do not guarantee in-order delivery. They are primarily intended to only ensure delivery of data to applications as quickly as possible at the transport layer. More specifically, unreliable QUIC supports real-time traffic, which works over unreliable wireless links particularly in situations where re-transmissions might degrade users' quality of experience. As such, the unreliable QUIC streams completely skip a retransmission timer and do not queue up the data packets for retransmission.

The semi-reliable QUIC streams are neither completely reliable nor completely unreliable. The semi-reliable QUIC streams in the data session initiate an acknowledgement (ACK) signal on dropping at least one data packet in the semi-reliable QUIC stream. However, the acknowledgement is not used for retransmission but guarantees in order delivery to the application. For example, the semi-reliable QUIC avoids queuing of data packets but adapts transmission of data packets based on the received acknowledgements. In an example, data packets may be transmitted at 100 MBps over a channel and on receiving acknowledgements indicating dropping of one or more data packets, a transmission rate may be adapted based on the acknowledgements to 70 Mbps from 100 Mbps, thereby ensuring better QoE for viewers. In another example, a real-time battle game such as, clash of clans might require in order delivery of user action sequence as out of order delivery may lead to undesirable results. As such, if a user moves from 1.1 to 1.2 to 1.3 in a play arena, the semi-reliable QUIC stream will make sure all three actions are in sequence whereas, the uQUIC out of delivery may result in sequence like 1.1 to 1.3 to 1.2. Hence, latest position co-ordinate of the user in uQUIC will be 1.2 (though it should be 1.3).

For example, the plurality of QUIC streams are dynamically selected either prior to establishing the data session or dynamically when the data session is in progress. It should be noted that the performance parameters of the data session may be continuously monitored and if degradation of performance parameters is continuously observed in the data session, the plurality of QUIC streams are selected to adapt to the prevailing network conditions. The method of dynamically determining the plurality of QUIC streams is explained with reference to FIGS. 1-6B.

FIG. 1 is a diagram illustrating an example wireless communication system 100, according to various embodiments.

The wireless communication system 100 depicts a viewer 102 operating an electronic device 104 for viewing/accessing content offered by a streaming server 120. The streaming server 120 is a network node providing digital media content and other media services over a communication network to the electronic devices of users/viewers. Some non-limiting examples of the digital media content may include content such as news content, sports related content, entertainment content, gaming content and the like. The media content offered by the streaming server may be embodied as streaming content such as livestreaming content or on-demand video streaming content. More specifically, the streaming content may include a plurality of QUIC streams as will be explained in detail later. It shall be noted that the wireless communication system 100 depicted for example purposes and the wireless communication system 100 may have a plurality of network nodes in which each network node performs a specific functionality. Some examples of the plurality of network nodes may be user equipment, server, switches, routers, and the like.

The viewer 102 may have downloaded a software application 106 (hereinafter referred to as an ‘application 106’ or an ‘app 106’) corresponding to services offered by the streaming server 120 on the electronic device 104. It is noted that the viewer 102 may use the electronic device 104, such as a smartphone, a laptop, a desktop, a personal computer, or any spatial computing device to view the media content provided by the streaming server 120. In one illustrative example, the viewer 102 may access a web interface associated with the application 106 associated with the services provided by the streaming server 120 on the electronic device 104. It is understood that the electronic device 104 may be in operative communication with a communication network 110, such as the Internet, enabled by a network provider, also known as an internet service provider (ISP). The electronic device 104 may connect to the communication network 110 using a wired network, a wireless network, or a combination of wired and wireless networks. Some non-limiting examples of wired networks may include the Ethernet, the local area network (LAN), a fiber-optic network, and the like. Some non-limiting examples of wireless networks may include the wireless LAN (WLAN), cellular networks, Bluetooth or ZigBee networks, and the like.

The electronic device 104 may fetch the web interface associated with the application 106 over the communication network 110 and cause the display of the web interface on a display screen (not shown) of the electronic device 104. In an illustrative example, the web interface may display a plurality of content titles corresponding to the media content offered by the streaming server 120 to its viewers. The content may include livestreaming content (e.g., live concerts, professional sports games, etc.) and non-livestreaming content (e.g., video-on-demand, vlogs, etc.). In an illustrative example, the viewer 102 may select a content title related to a live event (e.g., a sports match) from among the plurality of content titles displayed on the display screen of the electronic device 104. This initiates the data session corresponding to the livestreaming content. It shall be noted that the data session may span over a defined time frame, for example, 30 minutes or duration of the media content.

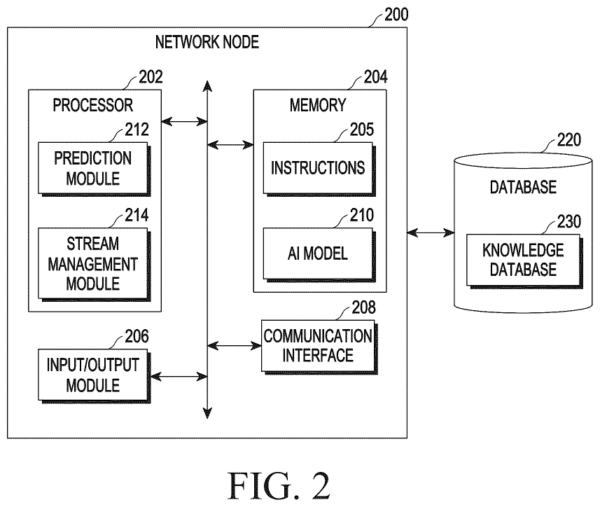

Various embodiments of the disclosure provide a method and a network node for dynamically selecting QUIC streams in a wireless communication system for the data session. The term ‘network node’ as used herein may refer, for example, to any node which acts as a connection point in a network infrastructure of a distributed wireless communication network. Each node is an endpoint for data transmissions or redistribution in the wireless communication network. Nodes have either a programmed or engineered capability to recognize, process and forward transmitted data to other network nodes. Some examples of network nodes include, but not limited to, routers, switches, hubs, gateways, user equipment, wireless base stations, and the like. It shall be noted that both physical and virtual instances of many of these types of nodes are possible. For example, current values associated with the one or more network parameters in real-time are used to predict new values associated with the one or more network parameters for the data session. The new values associated with the one or more network parameters may be predicted using a deep reinforcement learning (DRL) model. Accordingly, the one or more network parameters may be used to identify and select a plurality of QUIC streams based on the new values associated with the one or more network parameters for the data session. The plurality of QUIC streams are multiplexed into a single socket and streamed in the wireless communication system 100. The network node for dynamically selecting QUIC streams in the wireless communication system 100 is explained in detail with reference to FIG. 2.

FIG. 2 is a block diagram illustrating an example configuration of a network node 200 for dynamically determining QUIC streams in the wireless communication system 100 for a data session, according to various embodiments.

As already explained, the network node 200 is any node in the wireless communication system 100 capable of performing one or more of the operations described herein. In an example, a user equipment (e.g., the electronic device 104) may dynamically determine QUIC streams to be received in conjunction to a data session. In another example, a base station such as, an evolved node B (eNodeB) in LTE, may perform the operations described herein for dynamically determining the QUIC streams to be streamed to the electronic device 104.

It should be noted that the disclosure is hereinafter explained with reference to a user equipment in the wireless communication system 100 such as, the electronic device 104. However, it shall be noted that embodiments of the disclosure may be practiced with other network nodes in the wireless communication system 100.

The network node 200 is depicted to include at least one processor (e.g., including processing circuitry) 202, a memory 204, an input/output module (e.g., including input/output circuitry) 206, and a communication interface (e.g., including communication circuitry) 208. It should be noted that, in an example embodiment, the network node 200 may include more or fewer components than those depicted herein. The various components of the network node 200 may be implemented using hardware, software, firmware or any combinations thereof. Further, the various components of the network node 200 may be operably coupled with each other. For example, various components of the network node 200 may be capable of communicating with each other using communication channel media (such as buses, interconnects, etc.).

In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. For example, the processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

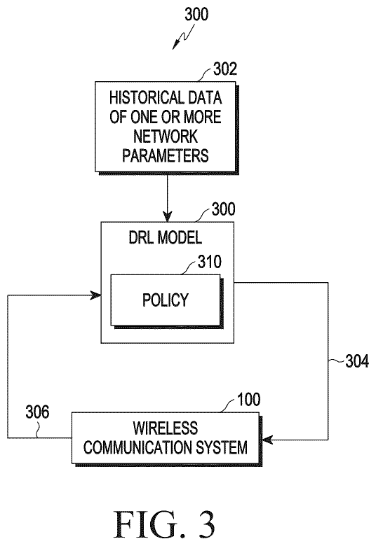

In an example embodiment, the memory 204 is capable of storing machine executable instructions, referred to herein as instructions 205. In an example embodiment, the processor 202 is embodied as an executor of software instructions. As such, the processor 202 is capable of executing the instructions 205 stored in the memory 204 to perform one or more operations described herein. Further, the memory 204 is capable of storing an artificial intelligence (AI) model 210. In an example embodiment, the AI model 210 is trained using historical data of one or more network parameters and stored in the memory 204. More specifically, a deep reinforcement learning (DRL) model (see, DRL model 300 in FIG. 3) is used to implement features of the disclosure.

The memory 204 may be any type of storage accessible to the processor 202 to perform respective functionalities, as will be explained in detail with reference to FIGS. 2 to 6B. For example, the memory 204 may include one or more volatile or non-volatile memories, or a combination thereof. For example, the memory 204 may be embodied as semiconductor memories, such as flash memory, mask ROM, PROM (programmable ROM), EPROM (erasable PROM), RAM (random access memory), etc. and the like.

In an example embodiment, the processor 202 may be configured to execute the instructions 205 for: (1) predicting new values associated with one or more network parameters for the data session based on the current values associated with the one or more network parameters using the AI model 210, (2) dynamically determine a plurality of QUIC streams related to the data session based on the new values associated with the one or more network parameters, (3) monitoring one or more performance parameters of the data session, (4) updating the AI model 210 based on the one or more performance parameters and the current values associated with the one or more network parameters. In an example embodiment, after dynamically determining the plurality of QUIC streams, the processor 202 is configured to: (1) stream the plurality of QUIC streams in the wireless communication system 100.

In an example embodiment, the I/O module 206 may include various circuitry and mechanisms configured to receive inputs from and provide outputs to peripheral devices such as, other network nodes (e.g., the electronic device 104, the streaming server 120) and/or an operator of the network node 200. The term ‘operator of the network node 200’ as used herein may refer to one or more individuals, whether directly or indirectly, associated with managing operations of the network node 200, for example, the viewer 102 associated with the electronic device 104. To enable reception of inputs and provide outputs to the network node 200, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like. It shall be noted that some network nodes in the wireless communication system 100 may not include all the components listed above in the input interface/output interface and hence it should be apparent to a person skilled in the art that embodiments of the disclosure may be practiced without the input interface/output interface. For example, if the network node 200 is a base station such as, an eNodeB, then all the components of the input interface and/or the output interface are not in the network node 200.

In an example embodiment, the communication interface 208 may include various communication circuitry and mechanisms configured to communicate with other entities in the wireless communication system 100 such as, other network nodes for accessing media content, transmitting media content or receiving media content. As such, the communication interface 208 is configured to receive current values associated with the one or more network parameters related to a data session in real-time. In an example, the viewer 102 may provide a selection input on a content/software application indicating the initiation of the data session. In another example, the data session may be predicted based on viewer browsing history prior to the viewer 102 providing the selection input. Accordingly, the current values associated with the one or more network parameters related to the data session may be collated in real-time. The one or more network parameters comprise at least one of: connection metrics, network condition and a type of service. The connection metrics includes information related to at least one of: packet loss, round trip time (RTT), packet arrival time, per packet interval, and size of packet. These features are fetched from a transport layer to understand the end-to-end channel capacity between network nodes in the wireless communication system 100. In general, the connection metrics include metrics about data being sent and received on a connection in the wireless communication system 100. The connection here may be between two different network nodes on the same wireless communication system 100.

The network condition includes at least one of: received signal strength indicator (RSSI), signal interference+noise ratio (SINR), radio access technology (RAT) type, carrier aggregation (CA) or non-CA, and downlink radio blocks (DRB) availability. In general, the network condition includes information related to network type and signal characteristics of the data transmitted through the network. In an example, a default network is identified based on a network communication interface as one of: cellular/Wi-Fi. Thereafter, the RAT or a band of Wi-Fi is used to collect features corresponding to a cross-layer. In an example, if Wi-Fi is used as the network communication interface, information related to link capacity, signal strength, frequency and MAC protocol data unit (MPDU) values are collected. In another example, if mobile network, then information related to the RSSI, SINR, CA, DRBs are collected.

The type of service includes at least one of: enhanced mobile broad band (eMBB), ultra-reliable low latency communications (URLLC), and massive machine-type communication (mMTC). More specifically, the type of service is one of the service defined in the 3rd generation partnership project long term evolution (3GPP LTE) standards. However, the disclosure is not limited to the specified types of services, and may also be applied to types of services following other standards. In an example, if the traffic is latency sensitive (e.g., URLLC or real time traffic), it is labelled as critical traffic. As such, download and non-elastic traffic are labelled as non-critical (also referred to herein as ‘best effort’) traffic. The current values associated with the one or more network parameters received in relation to the data session in real-time are processed to determine the plurality of QUIC streams as will be explained in detail later.

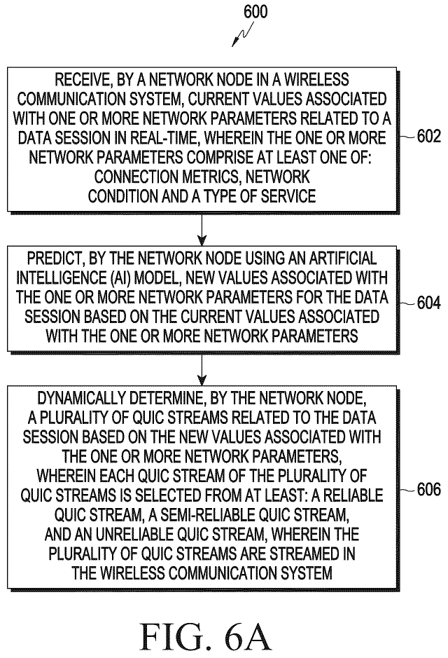

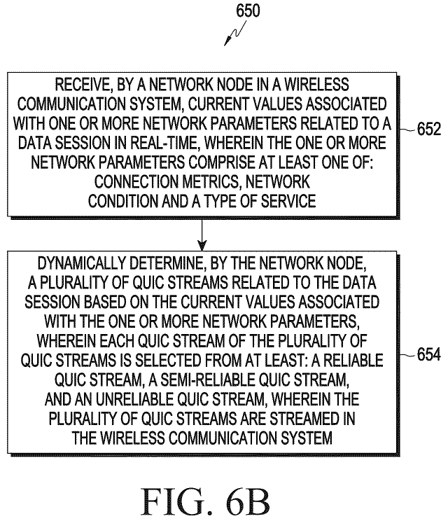

The network node 200 is depicted to be in operative communication with a database 220. In an example embodiment, the database 220 is configured to store information related to each data session such as, current values associated with the one or more network parameters, new values associated with the one or more network parameters, types of QUIC streams associated with each data session, performance parameters of the AI model 210, and the like. The database 220 is also configured to store a plurality of update policies for updating the AI model 210. In an example, an update policy may specifically indicate a network parameter to be updated based on the one or more performance parameters of the AI model 210 and the current values associated with the one or more network parameters associated with a data session. In another example, an update policy may invoke a specific training algorithm to update the AI model 210. In yet another example, an update policy may indicate that the AI model 210 to always select a specific stream for certain data types, for example, downloads are always supposed to be reliable streams. The database 220 may also include a plurality of predefined rules which may be used in a heuristic based approach for determining the plurality of QUIC streams. The plurality of predefined rules and use in the heuristic based approach are explained in greater detail below with reference to FIG. 6B.

The database 220 includes a knowledge database 230 which is configured to store information related to network parameters and corresponding performance parameters of data sessions. The knowledge database 230 acts a repository of information to store both structured and unstructured information used by the stream management module (e.g., including various circuitry and/or executable program instructions) 214 for determining the plurality of QUIC streams for each data session. In an example, the information related to the network parameters, plurality of QUIC streams of the data session and performance parameters of the data session may be arranged in a look-up table. The look-up table may be used as a reference to select the QUIC streams for the data session based on the new values associated with the one or more network parameters.

The database 220 may include multiple storage units such as hard disks and/or solid-state disks in a redundant array of inexpensive disks (RAID) configuration. In an example embodiment, the database 220 may include a storage area network (SAN) and/or a network attached storage (NAS) system. In an example embodiment, the database 220 may correspond to a distributed storage system, wherein individual databases are configured to store custom information, such as stream selection policies, training algorithms for AI model 210, historical network parameters, information related to other network nodes in the wireless communication system 100, etc.

In an example embodiment, the database 220 is integrated within the network node 200. For example, the network node 200 may include one or more hard disk drives as the database 220. In an example embodiment, the database 220 is external to the network node 200 and may be accessed by the network node 200 using a storage interface (not shown in FIG. 2). The storage interface is any component capable of providing the processor 202 with access to the database 220. The storage interface may include, for example, an advanced technology attachment (ATA) adapter, a serial ATA (SATA) adapter, a small computer system interface (SCSI) adapter, a RAID controller, a SAN adapter, a network adapter, and/or any component providing the processor 202 with access to the database 220.

As already explained, the communication interface 208 is configured to receive the current values associated with the one or more network parameters related to a data session in real-time from the wireless communication system 100. The current values associated with the one or more network parameters may be received from another network node in the wireless communication system 100. It shall be noted that the network node may be configured to monitor the current values associated with the one or more network parameters in the wireless communication system 100. In a non-limiting example, a third party server may be deployed to monitor the current values associated with the one or more network parameters in the wireless communication system 100 in real-time and provide the information related to the current values associated with the one or more network parameters when requested by other network nodes in the wireless communication system 100. The current values associated with the one or more network parameters are forwarded to the processor 202.

The processor 202 in conjunction with the instructions of the memory 204 is configured to receive the current values associated with the one or more network parameters and determine the plurality of QUIC streams for the data session. As such, the processor 202 forwards the current values associated with the one or more network parameters to the prediction module (e.g., including various circuitry and/or executable program instructions) 212. The prediction module 212 is configured to predict new values associated with the one or more network parameters for the data session based on the current values associated with the one or more network parameters using the AI model 210.

Referring now to FIG. 3, a diagram 300 illustrating an example AI model 210 is depicted, according to various embodiments.

In an example embodiment, the AI model 210 may be a DRL model 300. It should be noted that embodiments of the disclosure are explained hereinafter with reference to the DRL model 300. However, it shall be noted that any AI model 210 other than the DRL model 300 may also be used to perform the functionalities that will be described hereinafter.

The DRL model 300 may refer, for example, to a machine learning model which is self-trained based on a reward mechanism in the wireless communication system 100. Therefore, during the training, the DRL model 300 selects a best action or path to gain maximum reward through observation in a specific scenario. For example, the DRL model 300 observes patterns in the wireless communication system 100 based on a variety of network conditions, type of service and connection metrics for establishing data sessions with best performance metric. In general, the DRL model 300 is trained in a dynamic environment (e.g., the wireless communication system 100) based on a trial and error method in which desired behavior is rewarded and undesired behaviors are punished.

In this example representation, the DRL model 300 is provided historical data of the one or more network parameters 302 corresponding to a plurality of training data sessions in the wireless communication system 100. For example, historical data of the one or more network parameters 302 corresponding to a plurality of training data sessions are provided to the DRL model 300. In general, the DRL model 300 is configured to perform an action 304 (e.g., select new values associated with the one or more network parameters for the data session) based on one or more network parameters provided from the historical data of the one or more network parameters 302. The performance metric of the wireless communication system 100 based on the action 304 of the DRL model 300 is evaluated to determine a reward metric 306. The reward metric 306 is a feedback signal that indicates performance of the DRL model 300 at a given time step. Accordingly, the action 304 that the DRL model 300 takes at every time step is a function of both the reward metric 306 and a state of the DRL model 300. The state of the DRL model 300 is a description of an environment the DRL model 300 is in at the give time step.

As such, a mapping from the state of the DRL model 300 to the action 304 is defined by a policy 310. The policy 310 defines the agent's way of behaving at a certain time, given a certain situation. In an example embodiment, the policy will be updated every time and training algorithms will be selected dynamically. In an example scenario, the viewer 102 may be availing only one type of service for specific time in the day every day, for example, live news at 8 AM every day. As such, the DRL model 300 understands such scenarios and updates the policy in such a way that during those times the training algorithm will be prepared in advance and the stream selection procedure will be automated to avoid any latency problems.

During the training phase, the DRL model 300 is configured to identify a plurality of patterns from the historical data of the one or more network parameters 302 and the corresponding plurality of training data sessions. In an example, information related to each data session packet loss, round trip time (RTT), packet arrival time, per packet interval, size of packet, received signal strength indicator (RSSI), signal interference+noise ratio (SINR), radio access technology (RAT) type, carrier aggregation (CA), and data radio bearer (DRB) availability and a type of service (e.g., enhanced mobile broad band (eMBB)) are provided to the DRL model 300 in conjunction with a training data session. As such, a performance metric associated with each training data session of the plurality of training data sessions is evaluated. The performance metric refers to an overall quality of the training data session. Some examples of the performance metric, include, but not limited to, RTT, latency, loss, video quality, QoE, any combination of the above and the like which represent quality of the data session. For example, a streaming video content (e.g., live concert) corresponding to a training data session T and associated network parameters are provided to the DRL model 300 for training. The DRL model 300 identifies patterns P1, P2 and P3 from the network parameters corresponding to the training data session S1. As an example, pattern P1 results in a RTT which is greater than 50 ms, pattern P2 results in RTT which is less than 20 ms of the streamed content. In another example, the DRL model 300 identifies pattern P4, P5 and P6 in which pattern P4 results in high quality video with low loss, low latency and high RTT, pattern P5 results in poor quality video with high loss, low latency, low RTT and pattern P6 results in a decent video quality with high loss, low latency and low RTT in the training data session S1. The performance metric (e.g., high/low RTT, good/poor video quality, high/low latency, etc.) are provided as feedback to the DRL model 300 in the form of rewards. Although one performance metric for evaluating the training data session is described herein, more than one performance metric may be evaluated from the training data session to provide feedback to the DRL model 300. For example, the performance metric is used to determine the reward metric 306 for the DRL model 300 which is provided as feedback to the DRL model 300. If the performance metric is greater than a performance threshold, then the reward metric 306 is a positive value and if the performance metric is less than a performance threshold, then the reward metric 306 is a negative value. This learning approach enables the DRL model 300 to make a series of decisions that maximizes or increases the reward metric 306 for the task without human intervention and without being explicitly programmed to complete the task. These patterns identified from the historical data of the one or more network parameters 302 and the training data session are used for predicting the new values associated with the one or more network parameters for the data session. In addition, viewer specific behavior may also be tracked over time and such behavioral patterns may also be used to update the policy 310. In general, the historical data of the one or more network parameters are used for reinforcement in the DRL model 300.

Referring now to FIG. 2, when the DRL model 300 trained on the historical data of the one or more network parameters 302 is provided with the current values associated with the one or more network parameters, the DRL model 300 predicts the current values associated with the one or more network parameters. The current values associated with the one or more network parameters are provided to the stream management module 214.

The stream management module 214 in conjunction with the instructions 205 stored in the memory module 204 is configured to dynamically determine a plurality of QUIC streams related to the data session based on the new values associated with the one or more network parameters. In an example embodiment, an AI model may be used analyze the information in the knowledge database 230 for interpreting and determining the plurality of QUIC streams for the data session. In an example, a clustering algorithm may be used to form a plurality of groups based on their similarity. The similarity may be based on the network parameters, performance parameters and type of software application (e.g., real-time gaming application, video streaming application, document sharing application, social networking application). As such, when new values associated with the one or more network parameters are received in the knowledge database 230, a cluster to which the new values associated with the one or more network parameters have a minimum statistical distance may be determined. Thereafter, the QUIC streams commonly used for such software applications in the cluster may be used to determine the plurality of QUIC streams. It shall be noted that in an example embodiment, each QUIC stream of the plurality of QUIC streams is selected from at least: a reliable QUIC stream, a semi-reliable QUIC stream, and an unreliable QUIC stream.

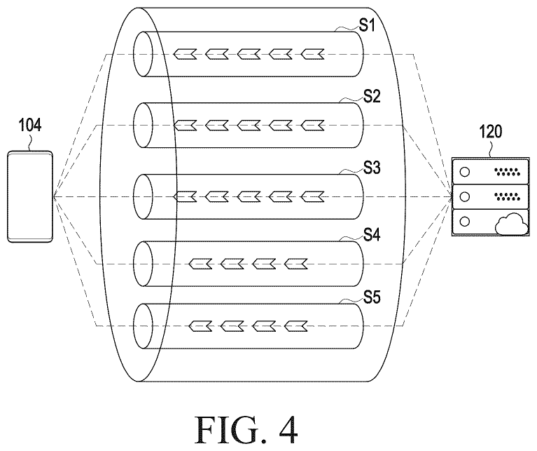

In an example, the viewer 102 may initiate a data session for playing a real-time combat game. As already explained, current values associated with the one or more network parameters are used to predict the new values associated with the one or more network parameters during the data session. In other words, the likelihood of the network parameters such as, RTT, packet arrival time, RSSI, SINR, DRB availability, per packet interval and type of data service during the data session may be predicted based on the current network parameters. More specifically, the DRL model 300 trained on the historical data of the current values associated with the one or more network parameters is used to predict the new values associated with the one or more network parameters for the real-time combat game. As such, the network node selects the plurality of the QUIC streams (S₁, S₂, S₃, S₄, S₅) (refer, e.g., to FIG. 4) related to the data session based on the new values associated with the one or more network parameters. In an example, the network node selects a reliable stream S₁ for download of the combat game, a reliable stream S₂ for download of the combat game, a reliable stream S₃ for the dashboard, a semi-reliable stream S₄ for the real-time gaming data, and an unreliable stream S₅ for audio input. In general, the network node 200 looks up the knowledge database 230 to select the plurality of QUIC streams. For example, the viewer 102 may have regularly played a real-time strategy game. As such, information related to all data sessions of the strategy game and network parameters related to the strategy game may have been stored in the knowledge database 230. When the data session related to the combat game is received, the new values associated with the one or more network parameters are predicted based on the current values associated with the one or more network parameters. The current values associated with the one or more network parameters are used to determine the plurality of QUIC streams by identifying similar one or more network parameters associated with different data sessions. More specifically, the new values associated with the one or more network parameters are mapped to the knowledge database 230 to identify types of QUIC streams used for similar streaming. In this example, the strategy game may use the streams S₁-R, S₂-R, S₃-R, S₄-SR, S₅-UR.

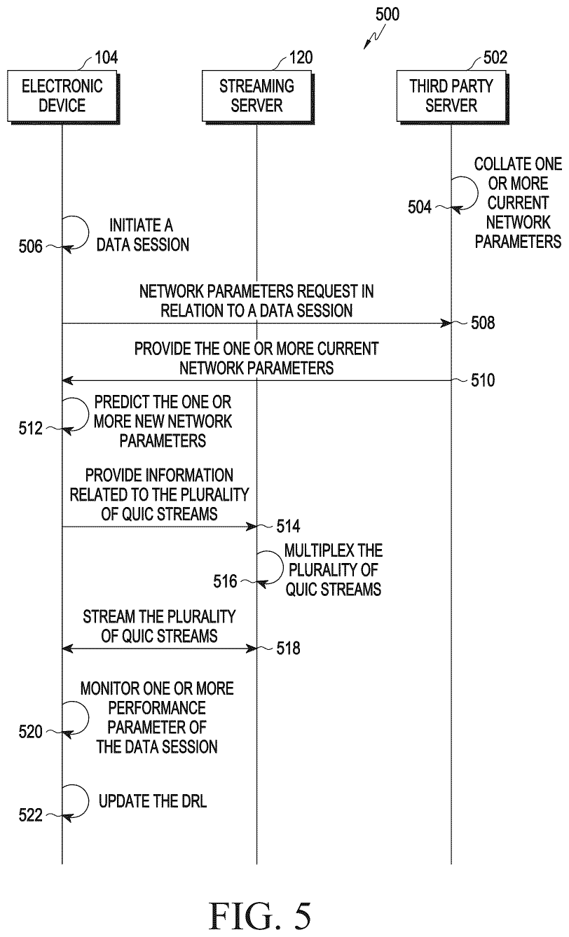

It should be noted that embodiments of the disclosure have been explained with reference to the electronic device 104 as a network node 200. However, embodiments of the disclosure may be practiced with other network nodes in the wireless communication system 100. Accordingly, if the operations of the network node are performed by a network node such as, the eNodeB, then the eNodeB also performs additional operation of streaming the plurality of QUIC streams over the wireless communication system 100. For example, any network node capable of transmitting the plurality of QUIC streams is also configured to multiplex the plurality of QUIC streams S₁-R, S₂-R, S₃-R, S₄-SR, S₅-UR into a single socket and stream the plurality of the QUIC streams to a client device, for example, the electronic device 104 (shown in FIG. 4). Further, it shall be noted that although embodiments of the disclosure have been described with reference to use of a AI model 210 (e.g., DRL model 300) to predict the new values of the one or more network parameters, the plurality of QUIC streams may also be determined by the QUIC node based on the current values of the one or more network parameters as explained with reference to FIG. 6B. A method for dynamically selecting the plurality of QUIC streams is explained in greater detail below with reference to FIG. 5.

FIG. 5 is a signal flow diagram 500 illustrating an example network node dynamically selecting QUIC streams in the wireless communication system 100 for a data session, according to various embodiments.

In this example representation, the network node dynamically selecting the QUIC streams in the wireless communication system 100 for the data session is the electronic device 104. It shall be noted that any other network node in the wireless communication system 100 may also perform the functions performed herein for dynamically determining the plurality of QUIC streams.

At 504, a third-party server 502 collates information related to current values associated with the one or more network parameters from the wireless communication system 100. The third-party server 502 may be a remote data gathering server monitoring activity of the viewer 102 on a plurality of web servers across a plurality of data sessions and associated one or more network parameters. For example, the third-party server 502 monitors viewer interactions with a plurality of enterprise interaction channels, such as enterprise websites in real-time and track network parameters related to the data session in real-time. The third-party server 502 collates the information related to such data sessions and stores them for further analysis in the database 220, for example, in the knowledge database 230. It shall be noted that although, the third-party server 502 is depicted to collate the information related to the current values associated with the one or more network parameters, functions of the third-party server 502 may be performed by any network node in the wireless communication system 100. For example, the electronic device 104 may collate the information related to the current values associated with the one or more network parameters and data sessions for storage and analysis.

At 506, the viewer 102 may initiate a data session on the electronic device 104. In an example, the viewer 102 provides a selection input on a livestreaming content (e.g., cricket match). In an example embodiment, the data session may be time bound. For example, a data session in relation to the livestreaming content may be first 10 overs of the cricket match or a data session may correspond to fixed time duration of 1 hour. In an example embodiment, the data session may be event bound. In an example, the data session may span till a batting team loses a wicket. In another example, the data session may span till an innings break. In general, the data session is defined and the selection input of the viewer 102 initiates the data session.

At 508, the electronic device 104 requests for current values associated with the one or more network parameters in relation to the data session from the third-party server 504. When the viewer 102 provides the selection input, prior to providing the livestreaming content, the electronic device 104 determines the plurality of QUIC streams for the data session. Accordingly, the electronic device requests the third-party server 502 to provide the current values associated with the one or more network parameters. The one or more network parameters may be one or more of: connection metrics, network condition and a type of service.

At 510, the third party server 502 provides the one or more current network parameters to the electronic device 104.

At 512, the electronic device 104 predicts new values associated with the one or more network parameters for the data session based on the current values associated with the one or more network parameters. The prediction of the new values associated with the one or more network parameters based on the current network parameters are explained with reference to FIG. 3.

The electronic device 104 determines the plurality of QUIC streams based on the new values associated with the one or more network parameters. For example, the new values associated with the one or more network parameters are mapped to network parameters corresponding to a plurality of historical data sessions in the knowledge database 230 for identifying a similar data session with similar network parameters. In an example, a similarity value may be computed by comparing each historical data session associated with one or more network parameters with the data session (e.g., data session requested by the viewer 102) and the new values associated with the one or more network parameters. The historical data session with highest similarity value is selected and types of QUIC streams associated with the historical data session are used to determine the plurality of QUIC streams. An example of determining the plurality of QUIC streams has already been explained with reference to FIG. 2.

At 514, the electronic device 104 provides information related to the plurality of QUIC streams to the streaming server 120.

At 516, the plurality of QUIC streams are multiplexed by the streaming server 120 into a single socket.

At 518, the multiplexed QUIC streams are streamed in the wireless communication system 100 by the streaming server 120. The QUIC streams are provided to the electronic device 104 in relation to the data session. More specifically, the livestreaming content of the cricket match is provided to the viewer 102. It shall be noted that if entire livestreaming content is segregated into a plurality of data sessions, then operations 504 to 520 are performed prior to each data session to select the plurality of QUIC streams.

At 520, one or more performance parameters of the data session are monitored continuously. The one or more performance parameters of the data session include, but not limited to, RTT, video quality, QoE, latency, loss, and the like. In general, the one or more performance parameters of the data session are used to evaluate a behavior metric of the DRL model 300 in the wireless communication system 100.

At 522, the DRL model is updated based on the one or more performance parameters. In an example embodiment, the behavior metric is compared with a behavior threshold. If the behavior metric of the DRL model 300 is less than the behavior threshold, then the DRL model 300 is updated based on the one or more performance parameters and the current values associated with the one or more network parameters. Alternatively, if the behavior metric of the DRL model 300 is greater than the behavior threshold, then the DRL model 300 is not updated. It shall be noted that the DRL model 300 may also be periodically updated based on new training data sessions and associated network parameters for improving performance of the DRL model 300. An example of a method for dynamically selecting the plurality of QUIC streams is explained next with reference to FIGS. 6A-6B.

FIG. 6A is a flowchart illustrating an example method 600 for dynamically selecting QUIC streams in the wireless communication system 100, according to various embodiments.

The method 600 depicted in the flow diagram may be executed by, for example, the network node 200 shown and explained with reference to FIGS. 2-5. Some examples of the network node include, but not limited to, the electronic device 104, the streaming server 120, the eNodeB or any other network node in the wireless communication system 100. Operations of the flow diagram, and combinations of operation in the flow diagram, may be implemented by, for example, hardware, firmware, a processor, circuitry and/or a different device associated with the execution of software that includes one or more computer program instructions. The operations of the method 600 are described herein with help of the processor 202 embodied within the network node 200 of the electronic device 104. It is noted that the operations of the method 600 may be described and/or practiced using one or more processors of a system/device other than the electronic device 104, for example, a system remotely placed from the electronic device 104 and communicably coupled with the electronic device 104 or the streaming server 120. The method 600 starts at operation 602.

At operation 602 of the method 600, current values associated with the one or more network parameters related to a data session in real-time are received, by a network node in the wireless communication system 100, such as, the electronic device 104 (shown and explained with reference to FIGS. 2 to 5). The one or more network parameters comprise at least one of: connection metrics, network condition and a type of service. The connection metrics comprises information related to at least one of: packet loss, round trip time (RTT), packet arrival time, per packet interval, and size of packet. The network condition comprises at least one of: received signal strength indicator (RSSI), signal interference+noise ratio (SINR), radio access technology (RAT) type, carrier aggregation (CA) or non-CA, and data radio bearer (DRB) availability. The type of service comprises at least one of: enhanced mobile broad band (eMBB), ultra-reliable low latency communications (URLLC), and massive machine-type communication (mMTC).

At operation 604 of the method 600, new values associated with the one or more network parameters for the data session are predicted based on the current values associated with the one or more network parameters by the network node using a deep reinforcement learning (DRL) model.

At operation 606 of the method 600, a plurality of QUIC streams related to the data session based on the new values associated with the one or more network parameters are dynamically determined, by the network node. In an example embodiment, each QUIC stream of the plurality of QUIC streams is selected from at least: a reliable QUIC stream, a semi-reliable QUIC stream, and an unreliable QUIC stream. The plurality of QUIC streams are streamed in the wireless communication system 100.

FIG. 6B is a flowchart illustrating an example method 650 for dynamically selecting QUIC streams in the wireless communication system 100, according to various embodiments.

The method 650 depicted in the flow diagram may be executed by, for example, the network node 200. Some examples of the network node include, but not limited to, the electronic device 104, the streaming server 120, eNodeB or any other network node in the wireless communication system 100. Operations of the flow diagram, and combinations of operation in the flow diagram, may be implemented by, for example, hardware, firmware, a processor, circuitry and/or a different device associated with the execution of software that includes one or more computer program instructions. The operations of the method 650 are described herein with help of the processor 202 embodied within the network node 200 of the electronic device 104. It is noted that the operations of the method 650 may be described and/or practiced using one or more processors of a system/device other than the electronic device 104, for example, a system remotely placed from the electronic device 104 and communicably coupled with the electronic device 104 or the streaming server 120. The method 650 starts at operation 652.

At operation 652 of the method 650, current values associated with one or more network parameters related to a data session in real-time is received, by a network node such as, the network node 200 in a wireless communication system 100. The one or more network parameters comprise at least one of: connection metrics, network condition and a type of service. The one or more network parameters are explained in detail with reference to FIG. 2 and are not repeated here.

At operation 654 of the method 650, a plurality of QUIC streams related to the data session are dynamically determined based on the current values associated with the one or more network parameters. In an example embodiment, a heuristic based approach is used to dynamically determine the plurality of QUIC streams for the data session. In an example embodiment, the network node applies a heuristic based approach based on at least one network parameter of the plurality of network parameters to determine the plurality of QUIC streams. More specifically, the heuristic based approach applies one or more pre-defined rules based on current values associated with the one or more network parameters to determine the plurality of QUIC streams.

In an example, the viewer 102 may be accessing a gaming application on the electronic device 104 while traveling. As such, the current values associated with at least one network condition, for example, current values of connection metrics such as, packet loss, round trip time (RTT), packet arrival time, per packet interval may indicate more packets are being dropped and an increased RTT. The heuristic based approach applies a predefined rule corresponding to the connection metrics to determine the plurality of QUIC streams. In this example, the plurality of QUIC streams may be selected as reliable QUIC streams based on the connection metrics. In an example, a predefined rule R₁ of the one or more predefined rules may indicate selecting the plurality of QUIC streams S₁, S₂, S₃, S₄ as reliable QUIC streams when RTT<50 ms. In another example, a predefined rule R₂ may indicate selecting the plurality of QUIC streams S₁, S₂, S₃, S₄ as unreliable QUIC streams when RTT>60 ms. In yet another example, a predefined rule R3 may indicate selecting streams S1, S2 and S4 as reliable QUIC streams and stream S3 as unreliable QUIC stream when 50 ms<RTT>60 ms.

Accordingly, each QUIC stream of the plurality of QUIC streams is selected from at least: a reliable QUIC stream, a semi-reliable QUIC stream, and an unreliable QUIC stream. The plurality of QUIC streams are streamed in the wireless communication system 100. It shall be noted that the heuristic based approach may determine the plurality of QUIC streams based on one network parameter as explained above or more than one network parameter may be considered for determining the plurality of QUIC streams for the data session using heuristics. For example, a predefined rule which uses connection metrics and network condition may indicate the plurality of QUIC streams S₁, S₂, S₃, S₄ to be selected as reliable QUIC streams when RTT<50 ms and SINR<0 dB.

The sequence of operations of the method 600/650 need not be necessarily executed in the same order as they are presented. Further, one or more operations may be grouped together and performed in form of a single step, or one operation may have several sub-steps that may be performed in parallel or in sequential manner.

The disclosed method with reference to FIGS. 6A and 6B, or one or more operations of the method 600 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, web book, tablet computing device, smart phone, or other mobile computing device). Such software may be executed, for example, on a single local computer.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the various example embodiments described herein. The term “computer-readable medium” should be understood to include tangible items and exclude carrier waves and transient signals, e.g., be non-transitory. Examples include random access memory (RAM), read-only memory (ROM), volatile memory, non-volatile memory, hard drives, compact disc (CD) ROMs, DVDs, flash drives, disks, and any other known physical storage media.

Various embodiments of the disclosure provide numerous advantages. Embodiments of the disclosure provide a method and system for dynamically determining QUIC streams in real-time applications. More specifically, the network node 200 understands the network condition of the wireless communication system 100 and dynamically assigns stream type for the data session. As such, the AI model 210 is configured to predict one or more new network conditions based on the one or more current network conditions. Such a method of predicting the new network parameters for the data session ensures, the QUIC streams are selected based on probable network condition during the data session. In general, the selection of the plurality of QUIC streams is done dynamically and intelligently based on DRL thereby, improving the overall user experience. The network node 200 may use a heuristic based approach to determine the plurality of QUIC streams. The reliable QUIC streams offers reliability whereas unreliable QUIC streams offer low latency. Further, the use of multiple different QUIC streams such as, Reliable QUIC streams, Unreliable QUIC streams, and Semi-reliable QUIC streams improves the latency of the wireless communication system 100 and thereby ensuring seamless service while streaming for real-time applications. Further, the Semi-Reliable QUIC is neither completely reliable nor completely unreliable and has major advantage which guarantees in order delivery to the real-time application. More specifically, the semi-reliable QUIC avoids queuing of data packets but adapts transmission of data packets based on received acknowledgements thereby providing valuable information for adapting the streaming of media content in the wireless communication system 100. In general, the multiplexing of the plurality of QUIC streams for the data session, for example, real-time streaming of gaming applications, selective re-transmission may recover the gaming data even during poor signal conditions. In general, during corner conditions, the streaming game content may see JUMPS and LAGS due to packet loss. In such cases, semi-reliable QUIC stream may help to avoid multiple lags and provide a smooth gaming experience. It selectively re-transmits specific packets even in un-reliable environment for better QoE.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation, even when the introductory phrases “one or more” or “at least one” and indefinite articles such as “a” or “an” (e.g., “a” and/or “an” should typically be interpreted to refer, for example, to “at least one” or “one or more” are included in the recitations; the same holds true for the use of definite articles used to introduce such recitations. In addition, even if a specific part of the introduced description recitation is explicitly recited, those skilled in the art will recognize that such recitation should typically be interpreted to refer, for example, to at least the recited number (e.g., the bare recitation of “two recitations,” without other modifiers, typically refers at least two recitations or two or more recitations).

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for selecting quick user datagram protocol (UDP) internet connection (QUIC) streams by a network node in wireless communication, comprising:
receiving, by the network node, current values associated with one or more network parameters related to a data session in real-time, wherein the one or more network parameters comprise at least one of: connection metrics, network condition and a type of service; and
determining, by the network node, a plurality of QUIC streams related to the data session based on the current values associated with the one or more network parameters,
wherein each QUIC stream of the plurality of QUIC streams is selected from at least: a reliable QUIC stream, a semi-reliable QUIC stream, and an unreliable QUIC stream, and
wherein the plurality of QUIC streams are streamed in the wireless communication system.

2. A method for selecting quick user datagram protocol (UDP) internet connection (QUIC) streams by a network node in wireless communication, comprising:
receiving, by the network node, current values associated with one or more network parameters related to a data session in real-time, wherein the one or more network parameters comprise at least one of: connection metrics, network condition and a type of service;
predicting, by the network node using an artificial intelligence (AI) model, new values associated with the one or more network parameters for the data session based on the current values associated with the one or more network parameters; and
determining, by the network node, a plurality of QUIC streams related to the data session based on the new values associated with the one or more network parameters,
wherein each QUIC stream of the plurality of QUIC streams is selected from at least: a reliable QUIC stream, a semi-reliable QUIC stream, and an unreliable QUIC stream, and
wherein the plurality of QUIC streams are streamed in the wireless communication system.

3. The method as claimed in claim 2, wherein the AI model comprises a deep reinforcement learning (DRL) model, and
wherein training the DRL model comprises:
providing historical data of the one or more network parameters corresponding to each data session of a plurality of training data sessions;
configuring the DRL model to identify a plurality of patterns from the historical data and corresponding training data session of the plurality of training data sessions, wherein a performance metric associated with each training data session of the plurality of training data sessions is evaluated; and
providing the performance metric as feedback to the DRL model.

4. The method as claimed in claim 2, further comprising:
monitoring, by the network node, one or more performance parameters of the data session; and
updating, by the network node, the AI model based on the one or more performance parameters and the current values associated with the one or more network parameters.

5. The method as claimed in claim 2, wherein the plurality of QUIC streams related to the data session are multiplexed into a single socket.

6. The method as claimed in claim 2, wherein each semi-reliable QUIC stream in the data session initiates an acknowledgement (ACK) signal on dropping at least one data packet in the semi-reliable QUIC stream.

7. A network node in a wireless communication system configured to select quick user datagram protocol (UDP) internet connection (QUIC) streams, comprising:
at least one processor comprising processing circuitry; and
memory storing an artificial intelligence (AI) model and instructions that when executed by the at least one processor individually and/or collectively, cause the network node to:
receive current values associated with the one or more network parameters related to a data session in real-time, wherein the one or more network parameters comprise at least one of: connection metrics, network condition and a type of service;
predict new values associated with the one or more network parameters for the data session based on the current values associated with the one or more network parameters using an artificial intelligence (AI) model; and
determine a plurality of QUIC streams related to the data session based on the new values associated with the one or more network parameters,
wherein each QUIC stream of the plurality of QUIC streams is selected from at least: a reliable QUIC stream, a semi-reliable QUIC stream, and an unreliable QUIC stream, and
wherein the plurality of QUIC streams are streamed in the wireless communication system.

8. The network node as claimed in claim 7, wherein the AI model comprises a deep reinforcement learning (DRL) model, and
wherein training the DRL model comprises:
providing historical data of the one or more network parameters corresponding to a plurality of training data sessions;
configuring the DRL model to identify a plurality of patterns from the historical data and the plurality of training data sessions, wherein a performance metric associated with each training data session of the plurality of training data sessions is evaluated; and
providing the performance metric as feedback to the DRL model.

9. The network node as claimed in claim 7, wherein the instructions, when executed by the at least one processor individually or collectively, further cause the network node to:
monitor one or more performance parameters of the data session; and
update the AI model based on the one or more performance parameters and the current values associated with the one or more network parameters.

10. The network node as claimed in claim 7, wherein the plurality of QUIC streams related to the data session are multiplexed into a single socket.

11. The network node as claimed in claim 7, wherein each semi-reliable QUIC stream in the data session initiates an acknowledgement (ACK) signal on dropping at least one data packet in the semi-reliable QUIC stream.

12. The method as claimed in claim 1, wherein the connection metrics comprise information related to at least one of: packet loss, round trip time (RTT), packet arrival time, per packet interval, and size of packet.

13. The method as claimed in claim 1, wherein the network condition comprises at least one of: received signal strength indicator (RSSI), signal interference noise ratio (SINR), radio access technology (RAT) type, carrier aggregation (CA) or non-CA, and downlink radio blocks (DRB) availability.

14. The method as claimed in claim 1, wherein the type of service comprises at least one of: enhanced mobile broad band (eMBB), ultra-reliable low latency communications (URLLC), and massive machine-type communication (mMTC).

15. The method as claimed in claim 2, wherein the connection metrics comprise information related to at least one of: packet loss, round trip time (RTT), packet arrival time, per packet interval, and size of packet.

16. The method as claimed in claim 2, wherein the network condition comprises at least one of: received signal strength indicator (RSSI), signal interference noise ratio (SINR), radio access technology (RAT) type, carrier aggregation (CA) or non-CA, and downlink radio blocks (DRB) availability.

17. The method as claimed in claim 2, wherein the type of service comprises at least one of: enhanced mobile broad band (eMBB), ultra-reliable low latency communications (URLLC), and massive machine-type communication (mMTC).

18. The network node as claimed in claim 10, wherein the connection metrics comprise information related to at least one of: packet loss, round trip time (RTT), packet arrival time, per packet interval, and size of packet.

19. The network node as claimed in claim 10, wherein the network condition comprises at least one of: received signal strength indicator (RSSI), signal interference noise ratio (SINR), radio access technology (RAT) type, carrier aggregation (CA) or non-CA, and downlink radio blocks (DRB) availability.

20. The network node as claimed in claim 10, wherein the type of service comprises at least one of: enhanced mobile broad band (eMBB), ultra-reliable low latency communications (URLLC), and massive machine-type communication (mMTC).
